(19) United States
(12) Patent Application Publication
(10) Pub. No.: US 2011/0151371 A1
(43) Pub. Date: Jun. 23, 2011

(54) TONER FOR ELECTROSTATIC LATENT IMAGE DEVELOPMENT AND IMAGE FORMING METHOD

(75) Inventors: Shinya OBARA, Tokyo (JP); Masahiro ANNO, Tokyo (JP); Satoshi UCHINO, Tokyo (JP); Hitomi MOTANI, Tokyo (JP); Hidehito HARUKI, Tokyo (JP)

(73) Assignee: KONICA MINOLTA BUSINESS TECHNOLOGIES, INC., Tokyo (JP)

(21) Appl. No.: 12/959,459

(22) Filed: Dec. 3, 2010

(30) Foreign Application Priority Data
Dec. 18, 2009 (JP) 2009-287402

(51) Int. Cl. G03G 9/08; G03G 9/087

(52) U.S. Cl. 430/110.1; 430/105; 430/137.21; 430/111.41

(57) ABSTRACT

A toner for electrostatic latent image development is disclosed, comprising colored particles containing a binder resin and a colorant, and an external-additive, wherein the external additive comprises boron nitride particles exhibiting a number average primary particle size of 10 to 500 nm. The production method of the toner is also disclosed.

This application claims priority from Japanese Patent Application No. 2009-287402, filed on Dec. 18, 2009, which is incorporated hereinto by reference.

### FIELD OF THE INVENTION

The present invention relates to a toner for an electrostatic latent image development and an image forming method by use of the toner.

### BACKGROUND OF THE INVENTION

Recently, high-performance of an image forming apparatus has been demanded, it is specifically important that its image formation can maintain stable performance as well as high image quality over long period of time and does not adversely affect resource saving.

To develop a solution therefore, it is of importance to achieve enhanced transferability of toner images. Enhanced transferability is necessary for formation of images with high quality over a long period of time. In addition to such an advantage, it also results in advantages such as reduction of toner consumption and simplification of a toner recovery system and renders it easier to employ countermeasures for resource saving and non-polluting.

A toner transfer system which has been broadly employed is performed by electrostatic-attractive force, while applying a bias of reversed polarity for a toner to the transfer material side. As a result, when using inorganic particles of low electric resistance as an external additive, such as titanium oxide with superior charge exchangeability, the charge distribution of a toner on a transfer material is easily varied due to charge injection in the transfer electric-field, easily causing transfer troubles.

Thus, to achieve enhanced efficiency of toner transfer, it is necessary to reduce physical adhesion of the toner and it is also necessary to inhibit variation of electrostatic charge.

Accordingly, there has been employed sol-gel processed silica, as an external additive, with enhanced electrical insulation (low charge exchangeability), as described in JP 2002-108001A, in which transferability at the initial stage was sufficiently secured but fixation of the sol-gel processed silica to the toner was insufficient, rendering it difficult onto maintain enhanced transferability over a long duration.

### SUMMARY OF THE INVENTION

To solve the foregoing problems, it is an object of the present invention to provide a toner used for development of an electrostatic latent image which achieves high image quality and enhanced durability and renders it easier to employ countermeasures for resource saving and is non-polluting, and an image forming method.

As a result of extensive study, the object of the invention was achieved by the following constitution.

1. One aspect of the invention is directed to a toner for electrostatic latent image development comprising colored particles containing a binder resin and a colorant, and an external-additive, wherein the external additive comprises boron nitride particles exhibiting a number average primary particle size of 10 to 500 nm.

2. Another aspect of the invention is directed to a method of producing a toner for electrostatic latent image development comprising the steps of forming colored particles containing a binder resin and a colorant, and adding an external-additive to the colored particles to form the colored particles with the attached external-additive, wherein the external-additive comprises boron nitride particles exhibiting a number average primary particle size of 10 to 500 nm.

3. Another aspect of the invention is directed to an image forming method comprising the steps of forming an electrostatic latent image, developing the electrostatic latent image with a toner to form a toner image, transferring the toner image to a transfer material, and fixing the transferred toner image, wherein the toner is a toner as described in the foregoing 1 or 2.

According to the present invention, there can be provided a toner for electrostatic latent image development which achieves high image quality and enhanced durability and renders it easier to employ countermeasures for resource saving and is non-polluting, and an image forming method by use of the same.

### BRIEF DESCRIPTION OF THE DRAWING

FIG. 1 shows a schematic sectional view of an example of an image forming apparatus related to the invention.

### DETAILED DESCRIPTION OF THE INVENTION

There will be further described the present invention.

To achieve enhanced transfer efficiency of a developed toner image, an external additive is required to exhibit enhanced electrical insulation property to reduce physical adhesion amount of toner particles to an intermediate transfer body and to be fixed onto colored particles.

Sol-gel process silica exhibiting a relatively volume resistivity and a relatively large particle size is the mainstream in the conventional technique for external additives. However, spherical large-sized silica particles are difficult to be fixed onto colored particles and transfer onto a carrier or migration to a recessed area on the colored particle surface renders it difficult to achieve a sufficient effect over a long period of time. On the contrary, boron nitride exhibits very high electrical insulation and high releasability and its planar structure renders it feasible to maintain a sufficient contact area with colored particles, whereby the foregoing conditions are satisfied.

External additive particles with a planar shape, which can advantageously maintain sufficient contact area with colored particles, result in few problem such as burying. Further, boron nitride exhibits a relatively high volume resistivity and the use of boron nitride provided with a low dielectric constant and high releasability results in enhanced transferability, whereby high quality images are stably obtained over a long duration.

### Boron Nitride:

Boron nitride is a compound of boron and nitrogen and a ceramic which is not naturally existent.

Similarly to carbon, boron nitride includes a hexagonal system which is stable under ordinary temperature and pressure and a cubic system which is stable under high pressure. Boron nitride is synthesized from melted boric acid anhydride (B₂O₃) and nitrogen or ammonia together with calcium phosphate as a catalyst.

A hexagonal boron nitride broadly forms a hexagonal network structure in which boron atoms are firmly combined and the force connecting layers in the vertical direction is the van der Waals force which is relatively weak, so that faces are slippery against each other. Therefore, boron nitride is also called “white graphite”.

The network structure is firmly formed and heat is easily transferred through lattice vibration, resulting in the highest heat conductivity among electric insulators. However, its thermal expansion coefficient is relatively low, corresponding to approximately one tenth of that of alumina. Such a high heat conductivity and a low thermal expansion coefficient result in the highest thermal shock resistance among ceramics, and even when rapidly cooled from 1500° C. or higher, no destruction is caused.

Boron nitride also exhibits a Mohs' hardness of 2 and relatively soft, as compared to general minerals, which is approximately equal to graphite.

However, in general, a planar boron nitride is relatively large in particle size and often exceeds 1.0 μm, so that it is excessively large as an external additive. In the present invention, it was found that since the Mohs hardness of boron nitride was approximately 2, it was crushable by using a wet-type grinder. The thus ground boron nitride can be externally added to colored particles in a conventional Henshell mixer.

It was proved that, to achieve advantageous effects of the invention, the number average primary particle size of boron nitride is preferably from 10 to 500 nm, more preferably 50 to 250 nm, and still more preferably 50 to 150 nm. A particle size falling within the foregoing range makes it feasible to be firmly fixed onto colored particles, resulting in enhanced transferability.

There are usable commonly known wet grinders to grind boron nitride. Of such grinders, a medium-type wet grinder using zirconia beads is preferred, which is easily controllable for particle size and renders it easy to form smaller particles.

The number average primary particle size of boron nitride can be determined in the following manner.

Specifically, toner particles are photographed by a scanning electron microscope at a magnification of 50,000 fold and 100 particles of boron nitride of photographic images are measured with respect to horizontal Feret diameter, from which an average value thereof is calculated. Herein, when a boron nitride particle is sandwiched with two vertical lines, the distance between the two vertical lines is defined as the horizontal Feret diameter. When the number of boron nitride particles on a single toner particle is insufficient, the number of toner particles to be observed are increased. Alternatively, the obtained photographic image is introduced to a scanner and boron nitride particles existing on the toner particle surface are subjected to a binary treatment in an image processing analyzer (LUZEX AP, produced by Nireco Co.) to determine the horizontal Feret diameter of 100 particles.

In cases when boron nitride particles exist in an aggregate form on the toner particle surface, the particle sizes of primary particles forming the aggregate are measured.

Further, boron nitride is directly photographed by a scanning electron microscope and the number average primary particle size can also be determined from the photographic image.

The amount of boron nitride to be added is preferably from 0.5 to 5.0 parts by mass, and more preferably from 1.0 to 4.0 parts by mass, based 100 parts by mass of colored particles.

Boron nitride preferably exhibits a volume resistivity of not less than 1×10¹³ Ω·cm and a planar form thereof is preferred. A volume resistivity less than these values is not preferred, which results in increased charge changeability, rendering it difficult to maintain electrostatic-charging performance and leading to transfer trouble. On the other hand, a spherical particle form may cause concern such that fixation onto a colored particle is insufficient.

The volume resistivity is determined in the following manner. On the lower electrode plate, as a measurement jig, of a pair of 20 cm² circular electrode plates (stainless steel plates) which are connected to an electrometer (trade name: KEITHLEY 610C, made by KEYTHLEY Co.) and a high-voltage power source (trade name: FLUKE 415B, made by FLUKE Co.), external additive particles are placed so that a 1-2 mm thick flat layer is formed. Then, the upper electrode plate is disposed on the external additive particles and while placing a 4 kg weight on the upper electrode plate to remove voids, the thickness of the external additive particle layer is measured; while applying a voltage of 1000 V to both electrode plates, the electric current value is measured and the volume resistivity (ρ) is determined based on the following equation (1):

Volume resistivity ρ=V×S÷(A−A₀)÷d (Ω·cm) Equation (1)

where V is the applied voltage (V), S is the electrode plate area (cm²), A is the measurement current value (A), A₀ is the initial current value (A) at an applied voltage of 0, and d is the particle layer thickness.

### Toner:

Next, there will be described a toner related to the invention.

The toner related to the invention comprises at least boron nitride which is externally added. Colored particles constituting the parent of the toner related to the invention (which are also referred to as toner parent particles), that is, particles at the stage before adding an external additive can be prepared by the methods known in the field of toner technology, for example, a dry granulating process such as a grinding method and a wet granulating process such as an emulsion polymerization coagulation method, a suspension polymerization method, a solution suspension method, a polyester molecular elongation method or the like.

The toner related to the invention preferably has a volume-based median diameter (D50v) of not less than 2 μm and not more than 8 μm. When the volume-based median diameter falls within the foregoing range, even extremely minute images, for example, at a level of 200 dpi (dpi: the number of dots per 1 inch or 2.54 cm) can be faithfully reproduced.

Thus, a volume-based median diameter falling within the foregoing range makes it possible to achieve faithfully reproduction of dot images including a photographic image, rendering it feasible to form highly precise color photographic images at a level equivalent to or higher than printed images. In the field of printing, specifically, on-demand printing which receives a print order at a level of some hundreds to some thousands of units, full-color, high image quality prints including highly precise photographic images can be delivered rapidly to customers.

The volume-based median diameter (D50v) of a toner can be measured and calculated by using Multisizer 3 (made by Beckman Coulter Co.) connected to a computer system for data processing.

A toner in an amount of 0.02 g is treated with a 20 ml surfactant solution (in which a neutral detergent containing a surfactant component is diluted 10 times with pure water) and then subjected to ultrasonic dispersion for 1 min. to prepare a toner dispersion. The toner dispersion is introduced by a pipette into a beaker containing ISOTON II (produced by Beckman Coulter Co.), placed in a sample stand until reaching a measured concentration of 5 to 10% and the analyzer count is set to 25000 particles. The aperture diameter of Multisizer 3 is 50 μm.

### Producing Method of Toner:

There will further be described a producing method of the toner related to the invention.

The toner related to the invention comprises colored particles containing at least a binder resin and a colorant, and external additive particles attached the surfaces of the colored particles, that is, toner particles with external additive particles attached to the surfaces of the colored particles. Colored particles (which are particles before being subjected to an external addition treatment) constituting the toner related to the invention, are not specifically restricted and can be produced by any conventional toner production method. Namely, a toner can be produced by application of a toner production method by a grinding process of producing a toner via kneading, grinding and classifying steps and a toner production method by a polymerization process of polymerizing a polymerizable monomer with controlling shape or size to form particles.

Examples of such a toner production method by a polymerization process include an emulsion polymerization coagulation method, a suspension polymerization method, a solution suspension method, and a polyester molecular elongation method. The toner production method by a polymerization process, as described earlier, can control the shape or particle size of toner particles in the particle forming process and is preferable for preparation of colored particles related to the invention.

Of these methods, production by an emulsion polymerization coagulation method is preferred and a production method by a process of mini-emulsion polymerization and coagulation is specifically preferred, in which resin particles of multi-stepped polymerization constitution and obtained through emulsion polymerization are coalesced (coagulation/fusion: particles being coagulated and simultaneously being thermally fused).

### Raw Material for Toner:

Next, a resin, a wax, a colorant and the like constituting the toner related to the invention will be described with reference to specific examples.

In cases when colored particles are prepared by a grinding method, a solution suspension method or the like, a resin constituting colored particles may use various resins known in the art, such as a vinyl resin, for example, styrene resin, (meth)acryl resin, styrene-(meth)acryl copolymer resin, and olefinic resin; a polyester resin, polyamide resin, polycarbonate resin, polyether resin, polyvinyl acetate) resin, polysulfone, epoxy resin, polyurethane resin and urea resin. These resins may be used singly or in combination.

On the other hand, when colored particles are produced through an emulsion polymerization coagulation method, an emulsion polymerization method or the like, polymerizable monomers to obtain a resin constituting colored particles can use polymerizable monomers, so-called polymerizable vinyl monomers, as shown below, singly or in combination.

Specific examples of such polymerizable vinyl monomers are shown below.

### (1) Styrene and Styrene Derivative:

styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene;

### (2) Methacryl Acid Ester Derivative:

methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, dimethylaminoethyl methacrylate;

### (3) Acrylic Acid Ester Derivative:

methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate;

### (4) Olefins:

ethylene, propylene, isopbutylene;

### (5) Vinyl Esters:

vinyl propionate, vinyl acetate, vinyl benzoate;

### (6) Vinyl Ethers:

vinyl methyl ether, vinyl ethyl ether;

### (7) Vinyl Ketones:

vinyl methyl ketone, vinyl ethyl ketone, vinyl hexyl ketone;

### (8) N-Vinyl Compounds:

N-vinylcarbazole, N-vinylindole, N-vinylpyrrolidone;

### (9) Others:

vinyl compounds such as vinylnaphthalene, vinylpyridine; acrylic acid or methacrylic acid derivatives such as acrylonitrile, methacrylonitrile and acrylamide.

Polymerizable vinyl monomers forming a resin usable in the toner related to the invention can also employ one containing an ionic dissociative group as a side chain of a monomer, such as a carboxyl group, a sulfonic acid group or a phosphoric acid group.

Examples of such a monomer containing a carboxyl group include acrylic acid, methacrylic acid, maleic acid, itaconic acid, cinnamic acid, fumaric acid, maleic acid monoalkyl ester and itaconic acid monoalkyl ester. Examples of a monomer containing a sulfonic acid group include styrene sulfonic acid, allylsulfosuccinic acid, and 2-acrylamido-2-methylpropane sulfonic acid. Examples of such one containing a phosphoric acid group include acidophosphooxyethyl methacrylate.

A resin of a crosslinking structure can also prepare by using poly-functional vinyl compounds. Examples thereof are as below:

ethylene glycol dimethacrylate, ethylene glycol diacrylate, diethylene glycol dimethacrylate, diethylene glycol diacrylate, triethylene glycol dimethacrylate, triethylene glycol diacrylate, neopentylene glycol dimethacrylate, and neopentylene glycol diacrylate.

Colorants usable in the toner relating to the present invention include those known in the art and specific examples thereof are as follows:

Examples of black colorants used for a black toner include carbon black such as Furnace Black, Channel Black, Acetylene Black, Thermal Black and Lamp Black and the like.

Further, colorants used for color toners employ pigments or dyes of organic compounds and specific examples are shown below.

Magenta or red colorants include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48, C.I. Pigment Red 53:1, C.I. Pigment Red 57:1, C.I. Pigment Red 60, C.I. Pigment Red 63, C.I. Pigment Red 64, C.I. Pigment Red 68, C.I. Pigment Red 81, C.I. Pigment Red 83, C.I. Pigment Red 87, Pigment Red 88, C.I. Pigment Red 89, C.I. Pigment Red 90, C.I. Pigment Red 112, C.I. Pigment Red 114, C.I. Pigment Red 122, C.I. Pigment Red 123, C.I. Pigment Red 139, C.I. Pigment Red 144, C.I. Pigment Red 149, C.I. Pigment Red 150, C.I. Pigment Red 163, C.I. Pigment Red 166, C.I. Pigment Red 170 C.I. Pigment Red 177, C.I. Pigment Red 178, C.I. Pigment Red 184, C.I. Pigment Red 202, C.I. Pigment Red 206, C.I. Pigment Red 207, C.I. Pigment Red 209, C.I. Pigment Red 222 C.I. Pigment Red 238 and C.I. Pigment Red 169.

Orange or yellow colorants include C.I. Pigment Orange 31, C.I. Pigment Orange 43, C.I. Pigment Yellow 12, C.I. Pigment Yellow 14, C.I. Pigment Yellow 15, C.I. Pigment Yellow 17, C.I. Pigment Yellow 74, C.I. Pigment Yellow 83 C.I. Pigment Yellow 93, C.I. Pigment Yellow 94, C.I., Pigment Yellow 138, C.I. Pigment Yellow 155, C.I. Pigment Yellow 162, C.I. Pigment Yellow 180 and C.I. Pigment Yellow 185.

Green or cyan colorants include C.I. Pigment Blue 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, C.I. Pigment Blue 17, C.I. Pigment Blue 60, C.I. Pigment Blue 62, C.I. Pigment Blue 66 and C.I. Pigment Green 7.

Dyes include C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19, C.I. Solvent Yellow 21, C.I. Solvent Yellow 33, C.I. Solvent Yellow 44, C.I. Solvent Yellow 56, C.I. Solvent Yellow 61, C.I. Solvent Yellow 77, C.I. Solvent Yellow 79, C.I. Solvent Yellow 80, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93 and C.I. Solvent Blue 95.

The foregoing colorants may be used alone or in combination. The colorant content is preferably from 1% to 30% by mass, and more preferably 2% to 20% by mass of the whole of a toner.

There will be described wax usable for the toner related to the invention. Waxes usable, for example, as a releasing agent, in the toner of the invention are those known in the art. Examples thereof include:

(1) polyolefin wax such as polyethylene wax and polypropylene wax, (2) long chain hydrocarbon wax such as paraffin wax and sasol wax, (3) dialkylketone type wax such as distearylketone,
(4) ester type wax such as carnauba wax, montan wax, trimethylolpropane tribehenate, pentaerythritol tetramyristate, pentaerythritol tetrabehenate, pentaerythritol diacetate dibehenate, glycerin tribehenate, 1,18-octadecanediol distearate, trimellitic acid tristearate, and distearyl meleate, and
(5) amide type wax such as ethylenediamine dibehenylamide and trimellitic acid tristearylamide.

The melting point of a wax usable in the invention is preferably 40 to 160° C., more preferably 50 to 120° C., and still more preferably 60 to 90° C. A melting point falling within the foregoing range ensures heat stability of toners and can achieve stable toner image formation without causing cold offsetting even when fixed at a relatively low temperature. The wax content of the toner is preferably in the range of 1% to 30% by mass, and more preferably 5% to 20%.

There are also usable external additives used for a toner, other than boron nitride (hereinafter, also denoted as other external additives). Specific examples of other additives are described below

External additives to be added to a toner are not specifically limited and various external additives known in the art are usable. Specific examples of such external additives include inorganic oxides such as silica, alumina, titanium oxide and calcium oxide; and metal salts of fatty acids such as calcium stearate and zinc stearate.

To achieve enhancements of heat storage stability or environment stability, these inorganic compounds are preferably subjected to a surface treatment with a silane coupling agent, a titanium coupling agent, a higher fatty acid or silicone oil.

The content of other external additives is preferably from 0.05 to 10 parts by mass, and more preferably from 0.1 to 5 parts by mass, based on 100 parts by mass of colored particles.

External additives may be added by using a commonly known mixer, such as a turbulent mixer, a Henshell mixer, a Nauta mixer and V-shape mixer.

### Developer:

Developers related to the invention may be used as a single component developer or two-component developer.

When the toner related to the invention is used as a two-component developer, magnetic particles used as a carrier of a two-component developer can use commonly known materials, e.g., metals such as iron, ferrite and magnetite and alloys of the foregoing metals and metals such as aluminum or lead. Of these, ferrite particles are preferred. A volume-based average particle size of a carrier is preferably from 15 to 100 μm, and more preferably 25 to 80 μm.

### Image Forming Method:

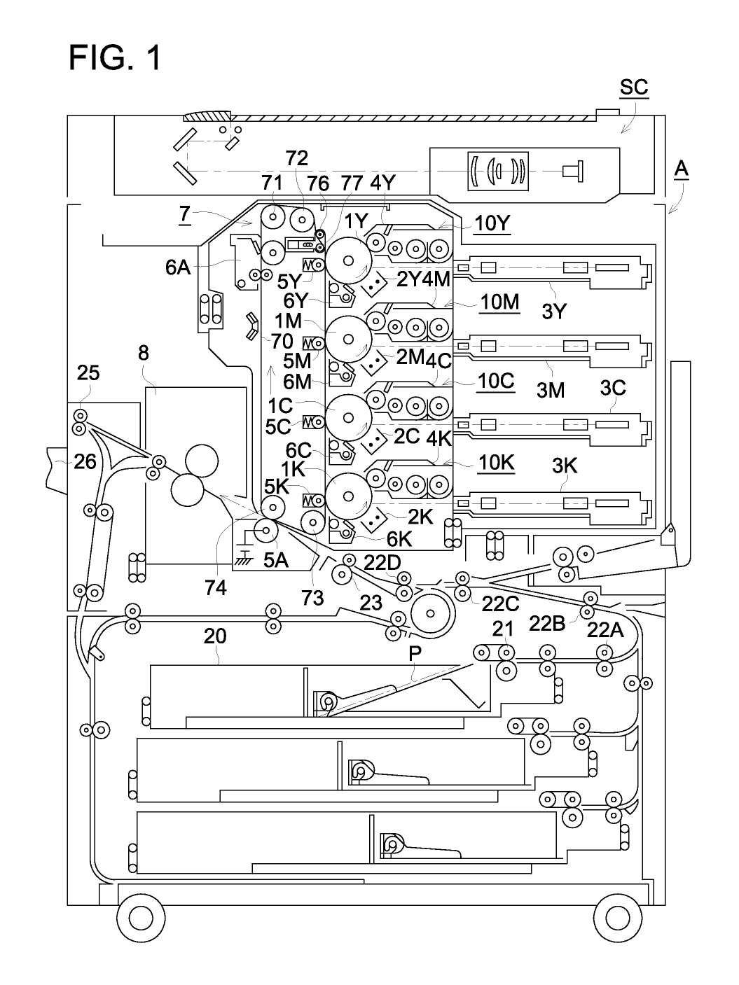

FIG. 1 shows a schematic sectional view of an exemplary image forming apparatus usable when the toner related to the invention is used as a two-component developer.

In FIG. 1, designations 1Y, 1M, 1C and 1K are each a photoreceptor; 4Y, 4M, 4C and 4K are each a developing device; 5Y, 5M, 5C and 5K are each a primary transfer roll as a primary transfer means; 5A is a secondary transfer roll as a secondary transfer means; 6Y, 6M, 6C and 6K are each a cleaning device; 7 is an intermediate transfer unit, 8 is a heat roll type fixing device, and 70 is an intermediate transfer body unit.

This image forming apparatus is called a tandem color image forming apparatus, which is, as a main constitution, comprised of plural image forming sections 10Y, 10M, 10C and 10K; an intermediate transfer material unit 7 of an endless belt form, a paper feeding and conveying means 21 to convey a recording member P and a heat-roll type fixing device 8 as a fixing means. Original image reading device SC is disposed in the upper section of an image forming apparatus body A.

As one of different color toner images of the respective photoreceptors, image forming section 10Y to form a yellow image comprises a drum-form photoreceptor 1Y as the first photoreceptor; an electrostatic-charging means 2Y, an exposure means 3Y, a developing means 4Y, a primary transfer roller 5Y as a primary transfer means; and a cleaning means 6Y, which are disposed around the photoreceptor 1Y. As another one of different color toner images of the respective photoreceptors, image forming section 10M to form a magenta image comprises a drum-form photoreceptor 1M as the first photoreceptor; an electrostatic-charging means 2M, an exposure means 3M, a developing means 4M, a primary transfer roller 5M as a primary transfer means; and a cleaning means 6M, which are disposed around the photoreceptor 1M.

Further, as one of different color toner images of the respective photoreceptors, image forming section 10C to form a cyan image comprises a drum-form photoreceptor 1C as the first photoreceptor; an electrostatic-charging means 2C, an exposure means 3C, a developing means 4C, a primary transfer roller 5C as a primary transfer means; and a cleaning means 6C, which are disposed around the photoreceptor 1C. Furthermore, as one of different color toner images of the respective photoreceptors, image forming section 10K to form a cyan image comprises a drum-form photoreceptor 1K as the first photoreceptor; an electrostatic-charging means 2K, an exposure means 3K, a developing means 4K, a primary transfer roller 5K as a primary transfer means; and a cleaning means 6K, which are disposed around the photoreceptor 1K.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10K are successively transferred onto the moving intermediate transfer material (70) of an endless belt form by primary transfer rollers 5Y, 5M, 5C and 5K, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 22B, 22C and 22D and a resist roller 23, and color images are secondarily transferred together on the recording member P. The color image-transferred recording member (P) is fixed by a heat-roll type fixing device 8, nipped by a paper discharge roller 25 and put onto a paper discharge tray 26 outside a machine.

After a color image is transferred onto the recording member P by a secondary transfer roller 5A as a secondary transfer means, an intermediate transfer material 70 of an endless belt form which separated the recording material P removes any residual toner by cleaning means 6A.

During the image forming process, the primary transfer roller 5K is always in contact with the photoreceptor 1K. Other primary transfer rollers 5Y, 5M and 5C are each in contact with the respectively corresponding photoreceptors 1Y, 1M and 1C only when forming a color image.

The secondary transfer roller 5A is in contact with the intermediate transfer material 70 of an endless belt form only when the recording member P passes through to perform secondary transfer.

Image forming sections 10Y, 10M, 10C and 10K are aligned vertically. The endless belt intermediate transfer material unit 7 is disposed on the left side of photoreceptors 1Y, 1M, 1C and 1K. The intermediate transfer material unit 7 comprises the endless belt intermediate transfer material 70 which can be turned via rollers 71, 72, 73, 74, 76 and 77 primary transfer rollers 5Y, 5M, 5C and 5K and cleaning means 6A.

Thus, toner images are formed on the photoreceptors 1Y, 1M, 1C and 1K via charging, exposure and development, toner images of the respective colors are superimposed on the endless belt intermediate transfer material 70, transferred together to the recording member P and fixed by applying pressure with heating in the fixing device 8. After having transferred the toner image onto the recording member P, the photoreceptor 1Y, 1M, 1C and 1K are each cleaned in cleaning devices 6Y, 6M, 6C and 6K to remove a remained toner and enter the next cycle of charging, exposure, and development to perform image formation.

### Examples

The present invention will be further described with reference to examples but the invention is by no means limited to these.

### Preparation of Colored Particle 1

### (1) Preparation of Resin Particle 1H:

In a reaction vessel fitted with a stirrer, a temperature sensor, a condenser and a nitrogen introducing device was dissolved 7.08 parts by mass of an anionic surfactant of sodium laurylsulfate in 3010 parts by mass of deionized water to prepare a surfactant solution (an aqueous medium). The temperature within the reaction vessel was raised to 80° C., while stirring the surfactant solution at a rate of 230 rpm under a nitrogen stream.

A polymerization initiator solution of 9.2 parts by mass of potassium persulfate (KPS) dissolved in 200 parts by mass of deionized water was added to the foregoing surfactant solution and the temperature within the reaction vessel was controlled to 75° C. Then, a mixed solution 1A composed of the following compounds was added thereto over 1 hour.

| | |
|---|---|
| Styrene | 69.4 parts by mass |
| n-Butylacrylate | 28.3 parts by mass |
| Methacrylic acid | 2.3 parts by mass |

Further, stirring continued at 75° C. over 2 hours to perform polymerization, whereby resin particle dispersion 1H was prepared.
(2) Preparation of resin particle 1HM:

Into a flask equipped with a stirrer were placed the following compounds:

| | |
|---|---|
| Styrene | 97.1 parts by mass |
| n-Butyl acrylate | 39.7 parts by mass |
| Methacrylic acid | 3.22 parts by mass |
| n-Octyl-3-mercaptoprpionic acid ester | 5.6 parts by mass |

and further thereto, the following compound was added:

| | |
|---|---|
| Pentaerythritol tetrabehanate | 98.0 parts by mass |

And then, the compound was dissolved, while being heating at 90° C. to prepare mixture 1B.

Further, into a reaction vessel fitted with a stirrer, a temperature sensor, a condenser and a nitrogen introducing device was a surfactant solution of 1.6 parts by mass of sodium lauryl sulfate dissolved in 2700 parts by mass of deionized water and heated at 98° C. To this surfactant solution was added 28 parts by mass of the foregoing resin particle dispersion in an amount of 28 parts by mass as a solid and thereto, the mixture 1B was added. Then, the mixture was dispersed for 8 hours by using a mechanical dispersing device provided with a circuit, CLEARMIX (produced by M Technique Co., Ltd.) to prepare a dispersion (emulsion).

Subsequently, to the foregoing dispersion were added an initiator solution of 5.1 parts by mass of potassium persulfate (KPS) dissolved in 80 parts by mass of deionized water and 750 parts by mass of deionized water, and the mixture was stirred at 98° C. for 12 hours to perform polymerization. There was thus prepared a dispersion of resin particle 1HM with a composite structure covering the surface of the resin particle 1H with a resin.

### (3) Preparation of Resin Particle 1HML:

To the foregoing resin particle dispersion 1HML was an initiator solution of 7.4 parts by mass of potassium persulfate (KPS) dissolved in 200 parts by mass of deionized water and controlled to a temperature of 80° C. Then, a mixture 1C composed of the compounds below was dropwise added thereto over one hour.

| | |
|---|---|
| Styrene | 277 parts by mass |
| n-Butyl acrylate | 113 parts by mass |
| Methacrylic acid | 9.21 parts by mass |
| n-Octyl-3-mercaptopropionic acid ester | 10.4 parts by mass |

After completion of addition, heating and stirring were continued at the foregoing temperature for two hours to perform polymerization. Thereafter, the reaction mixture was cooled to 28° C. to prepare a dispersion of resin particle 1HML with a composite structure covering the surface of the resin particle 1HM with a resin.

### (4) Preparation of Colorant Dispersion 1BK:

To 1600 parts by mass of deionized water was added 90 parts by mass of an anionic surfactant, sodium laurate with stirring to prepare a surfactant solution. While stirring the surfactant solution, 400 parts by mass of a colorant, carbon black Regal 330R (produced by Cabot Corporation.) was gradually added thereto.

After adding carbon black, a dispersing treatment was conducted by a mechanical dispersing device CLEARMIX (produced by M Technique Co., Ltd.) until the particle size of the carbon black reached 200 nm, whereby a colorant dispersion 1Bk was prepared.

### Preparation of Colored Particle 1:

Into a reaction vessel fitted with a stirrer, a temperature sensor, a condenser and a nitrogen introducing device were added 360 parts by mass at a solid content of the dispersion of resin particle 1HML, 1800 parts by mass of deionized water and 28.8 parts by mass at a solid content of the colorant dispersion 1Bk. Subsequently, the temperature within the reaction vessel was controlled to 30° C. and the pH was adjusted to 10.6 with adding an aqueous 5 mol/L sodium hydroxide solution.

After completing the foregoing adjustment, an aqueous solution of 52.6 parts by mass of magnesium chloride hexahydrate dissolved in 72 parts by mass of deionized water was added over 10 minutes, while stirring at 30° C. After completion of addition, the reaction mixture was allowed to stand for 3 minutes.

Thereafter, the temperature of the reaction mixture was raised to 75° C. over 60 minutes to initiate coagulation of the particles. Coagulation was continued, while measuring the particle size of coagulated particles by Multisizer 3 (produced by Beckman Coulter Co.).

When the volume-based median diameter of coagulated particles reached 6.5 μm, an aqueous solution of 115 parts by mass of sodium chloride dissolved in 700 parts by mass of deionized water was added thereto to terminate particle growth. Further, ripening was carried out at 90° C. over 6 hours with stirring to continue fusion of particles. Thereafter, the reaction system was cooled to 30° C. and stirring was stopped.

Colored particles which were thus prepared through coagulation and fusion were subjected to solid-liquid separation and repeatedly washed several times with 35° C. deionized water, whereby colored particle 1 was prepared.

### Preparation of External Additive

### (1) Preparation of Boron Nitride 1:

Deionized water was added to particulate boron nitride with an average particle size of 30 μm so that the ratio of boron nitride to deionized water was 40/60. Further thereto, an aqueous-soluble cationic copolymer dispersion was added in an amount of 0.02 part by mass per 100 parts by mass of boron nitride and mixed with zirconia beads of 0.3 mm diameter by using a table Attritor-type medium-stirring mill, and was subjected to wet-grinding at a filling ratio of 170% and a circumference rate of 10 msec. Thereafter, zirconia beads were separated and after being washed with deionized water and dried by a medium-fluidized dryer, boron nitride 1 was prepared. The thus prepared boron nitride 1 exhibited a number average primary particle size of 50 nm and a volume resistivity of 3.5×10¹⁴ Ω·cm.

### (2) Preparation of Boron Nitrides 2-5:

Boron nitrides 2-5 were each prepared in the same manner as the foregoing boron nitride 1, except that grinding conditions were varied.

### (3) Preparation of Graphite 1-2, Mica 1-2 and Kaolin 1-2:

Graphite 1 and 2, mica 1 and 2, kaolin 1 and 2 were each prepared in the same manner as the foregoing boron nitride 1, except that boron nitride was replaced by graphite, mica or kaolin and grinding conditions were varied.

### (4) Preparation of Silica 1:

Commercially available sol-gel processed silica (produced by Shinetsu Kagaku Kogyo Co. Ltd.) was also prepared, which is hereinafter also referred to simply as silica.

Boron nitrides 2-5, graphites 1-2, micas 1-2, kaolins 1-2 and silica 1 are shown in Table 1, with respect to number average primary particle size and the volume resistivity.

### Preparation of Toner 1-12

(1) Preparation of toner 1:

To 100 parts by mass of the foregoing colored particle 1 were added following compounds as an external additive.

| | |
|---|---|
| Boron nitride 1 | 2.5 parts by mass |
| Hydrophobic silica (number average | 1.0 part by mass |
| primary particle size: 12 nm) | |
| Hydrophobic titania (number average | 0.5 part by mass |
| primary particle size: 12 nm) | |

An external additive treatment was conducted by using a Henshell mixer (produced by Mitsui Kozan Co., Ltd. at a stirring blade convergence of 35 msec at a temperature of 30° C. and coarse particles were removed by using a sieve with a 45 μm opening to prepare Toner 1.

(2) Preparation of toners 2-12:

Toners 2-12 were each prepared in the same manner as the toner 1, except that the born nitride 1 added to the colored particle 1 was replaced by any one of boron nitrides 2-5, graphites 1-2, micas 1-1, kaolins 1-2 and silica 1.

### Preparation of Developer

To a high-speed mixer installed with a stirring blade were placed 100 parts by mass of ferrite and 5 parts by mass of copolymer resin particles of cyclohexyl methacrylate/methyl methacrylate (copolymerization ratio: 5/5) and mixed at 120° C. for 30 minutes to form a resin coat layer on the surface of a ferrite core by the action of mechanical impact force, whereby a carrier having a volume-based median diameter of 40 μm was prepared.

The volume-based median diameter of a carrier was measured by a laser refraction type particle size analyzer, HELOS (produced by SYMPATEC Co.).

Each of the prepared toners 1-12 was added to the foregoing carrier so that the toner content was 7% by mass, and placed into a micro-type V-shape mixer (produced by Tsutsui Rikagakuki Co., Ltd.) and mixed at a rotation rate of 45 rpm for 30 minutes, whereby developers 1-12 were each prepared.

### Evaluation

A commercially available full-color hybrid machine bizhub PRO C6500 (produced by Konica Minolta Business Technologies Inc.) was used and thereto, each of the foregoing developers was placed and evaluated.

### Transferability:

A 10 centimeters square solid image was printed at the initial stage and at the time after printing 5,000 blank sheets, and the mass of a black toner developed and attached onto an image carrier (photoreceptor) and the mass of a black toner transferred and attached onto fine-quality paper were each measured and a transfer efficiency defined below was calculated as a measure of transferability.

A transfer efficiency of not less than 80% was judged to be acceptable in practice.

Transfer efficiency=[(amount of a black toner attached onto fine-quality paper)/(amount of a black toner attached onto photoreceptor)]×100(%)

Characteristics of external additives and evaluation results of their performances are shown in Table 1.

TABLE 1

| | | | | | Transferability | |
|---|---|---|---|---|---|---|
| | | | | | (%) | |
| | | | | | | After |
| | | | Particle | Volume | | Printing |
| Example | Toner | External | Size | Resistivity | Initial | 5000 |
| No. | No. | Additive | (nm) | (Ω · cm) | Stage | Sheets |
| 1 | 1 | Boron nitride 1 | 50 | 3.5 × 10¹⁴ | 95 | 94 |
| 2 | 2 | Boron nitride 2 | 150 | 2.4 × 10¹⁴ | 98 | 97 |
| 3 | 3 | Boron nitride 3 | 250 | 7.0 × 10¹³ | 92 | 88 |
| 4 | 4 | Boron nitride 4 | 500 | 8.5 × 10¹³ | 86 | 80 |
| Comp. 1 | 5 | Boron nitride 5 | 550 | 4.2 × 10¹³ | 81 | 75 |
| Comp. 2 | 6 | Graphite 1 | 50 | 5.5 × 10¹⁰ | 75 | 65 |
| Comp. 3 | 7 | Graphite 2 | 120 | 8.4 × 10¹⁰ | 77 | 71 |
| Comp. 4 | 8 | Mica 1 | 50 | 5.5 × 10¹³ | 83 | 77 |
| Comp. 5 | 9 | Mica 2 | 140 | 5.5 × 10¹³ | 88 | 73 |
| Comp. 6 | 10 | Kaolin 1 | 60 | 4.9 × 10¹² | 82 | 71 |
| Comp. 7 | 11 | Kaolin 2 | 120 | 2.4 × 10¹³ | 84 | 65 |
| Comp. 8 | 12 | Silica 1 | 110 | 4.4 × 10¹³ | 92 | 76 |

As is apparent from Table 1, it was proved that Examples 1 to 4 according to the invention exhibited superior characteristics and on the contrary, Comparisons 1 to 8 were inferior in characteristics.

What is claimed is:

1. A toner for electrostatic latent image development comprising toner particles each comprising a colored particle containing a binder resin and a colorant, and an external-additive, wherein the external additive comprises boron nitride particles exhibiting a number average primary particle size of 10 to 500 nm.

2. The toner of claim 1, wherein the boron nitride particles exhibit an electrical volume resistivity of not less than 1×10¹³ Ω·cm.

3. The toner of claim 1, wherein the boron nitride particles exhibit a number average primary particle size of 50 to 250 nm.

4. The toner of claim 1, wherein the boron nitride particles exhibit a number average primary particle size of 50 to 150 nm.

5. The toner of claim 1, wherein the boron nitride particles are contained in an amount of 0.5 to 5.0 parts by mass, based on 100 parts by mass of the colored particles.

6. A method of producing a toner for electrostatic latent image development comprising toner particles, the method comprising the steps of:
forming colored particles containing a binder resin and a colorant, and
adding an external-additive to the colored particles to form toner particles with the external-additive attached to the colored particles,
wherein the external-additive comprises boron nitride particles exhibiting a number average primary particle size of 10 to 500 nm.

7. The method of claim 6, wherein the boron nitride particles exhibit an electrical volume resistivity of not less than 1×10¹³ Ω·cm.

8. The method of claim 6, wherein the boron nitride particles exhibit a number average primary particle size of 50 to 250 nm.

9. The method of claim 6, wherein the boron nitride particles exhibit a number average primary particle size of 50 to 150 nm.

10. The method of claim 6, wherein the boron nitride particles are contained in an amount of 0.5 to 5.0 parts by mass, based on 100 parts by mass of the colored particles.
